(19) United States
(12) Patent Application Publication
(10) Pub. No.: US 2013/0298686 A1
(43) Pub. Date: Nov. 14, 2013

(54) DEVICE AND METHOD FOR MONITORING A ROTOR

(71) Applicants: Eric Royer, Serres Morlaas (FR); Antoine Yvan Alexandre Vallon, Pau (FR)

(72) Inventors: Eric Royer, Serres Morlaas (FR); Antoine Yvan Alexandre Vallon, Pau (FR)

(73) Assignee: Turbomeca, Bordes (FR)

(21) Appl. No.: 13/978,308

(22) PCT Filed: Jan. 3, 2012
(86) PCT No.: PCT/FR12/50004

§ 371 Date: Jul. 3, 2013

(30) Foreign Application Priority Data
Jan. 7, 2011 (FR) 1150117

(51) Int. Cl. G01H 1/00

(52) U.S. Cl. CPC G01H 1/006
USPC 73/660

(57) ABSTRACT

A monitoring device for monitoring rotors of turbines, including: an acoustic sensor; and a sound waveguide for connecting the acoustic sensor to a sensing point close to the rotor of the turbine. The acoustic sensor is configured to detect, as soundwaves, pressure fluctuations due to pressure differences between suction and pressure sides of blades of the rotor as they move past in proximity of a sensing point. A method of monitoring a rotor of a turbine transmits pressure fluctuations due to pressure differences between suction sides and pressure sides of blades of the rotor going past the proximity of a sensing point by a sound waveguide to an acoustic sensor to be picked up as soundwaves.

The present invention relates to devices, methods, and systems for monitoring a turbine rotor.

Certifying a turbine engine requires a high level of integrity to be demonstrated for rotary assemblies, where the term “rotary assembly” designates all of the components that are caused to rotate and that contain kinetic energy while the engine is in operation, such as the rotors of turbines and compressors, and also the connection and transmission shafts. More precisely, in the field of aviation in particular, certification regulations normally require that no mechanical failure might lead to an affect that is dangerous. That is why it is important to be able to monitor a set of parameters relating to rotary assemblies, and more particularly to turbine rotors, including in particular speed of rotation. In this way, the engine may be stopped immediately in the event of a failure that might otherwise cause it to pass into overspeed.

Nevertheless, the environment of a turbine, and in particular its temperature, which may be about 1500° C., makes it very difficult to monitor parameters of its rotor directly, and in particular to monitor its speed. Typically, the speed of the turbine rotor is thus measured indirectly in a cold zone, remote from the turbine, by means of a variable reluctance sensor and a phonic wheel driven by a shaft secured to the turbine rotor. The drawback of that conventional solution is that in the event of breakage in the shaft providing the mechanical connection between the turbine rotor and the phonic wheel, that device for indirectly monitoring the rotor may indicate a speed that is less than the real speed of the rotor, and if the engine is regulated on the basis of this erroneous speed measurement, that might therefore give rise to the engine beginning to overspeed, with consequences that are potentially very serious.

The certification regulations for turbine engines are tending towards ever increasing safety, and any risk, even if very small, of the shaft driving the phonic wheel breaking is no longer acceptable.

Alternative solutions have therefore been considered, making it possible in particular to measure the speed of the turbine rotor directly. For that purpose, both capacitive sensors and optical sensors have already been proposed.

Capacitive sensors are proximity sensors that make it possible to detect items, and in particular metal items such as turbine blades, when they come within a detection field of the sensor, by modifying the capacitance of the coupling between two electrodes of the sensor that forms a capacitor. Nevertheless, although capacitive sensors exist that are capable of operating at the temperatures that are to be found in the core of such a turbine, the energy of the signals transmitted by such sensors is very low, of the order of a few picofarads, which makes reliable measurements difficult.

Optical sensors are sensors that enable items such as turbine blades to be detected by interrupting or reflecting a light beam, and in particular a laser beam. Nevertheless, optical sensors are generally too fragile for use in the difficult environment of a high temperature turbine.

Alternatively, proposals are made in U.S. Pat. No. 5,479,826 to use a sensor comprising a microwave transceiver connected by a waveguide to a sensing point in the proximity of the blades of the rotor. In the context of the present description, the term “waveguide” is used to mean a structure serving to guide the propagation of waves in at least one predetermined direction. Thus, such a microwave waveguide serves to guide the propagation of microwaves from the transceiver towards the sensing point, and in return to guide them back to the transceiver after being reflected on the blades moving past in the proximity of the sensing point. Thus, that sensor can detect the passage of blades by the way they modify the impedance of the waveguide. Nevertheless, that device remains relatively complex, with the drawbacks in terms of cost and reliability that that involves.

Yet another device for monitoring a turbine rotor is disclosed in US patent application No. 2010/0011868. That prior art monitoring device has an acoustic sensor and a first sound waveguide for connecting said acoustic sensor to a sensing point in the proximity of said turbine rotor. In the context of the present disclosure, the term “soundwave” is used to mean any kind of longitudinal mechanical wave propagating through a fluid or solid medium as a result of its elasticity, with this being independent of its frequency range. The term “sound waveguide” is therefore used to mean a structure that is adapted to guiding the propagation of such longitudinal mechanical waves. Typically, such a sound waveguide is in the form of a hollow duct that is elongate in the desired direction for soundwave propagation. In operation, the acoustic sensor detects the passage of the rotor blades by modulation of the amplitude of an acoustic signal sent by an acoustic emitter through a second sound waveguide parallel to the first waveguide towards an emission point that is also situated in the proximity of the turbine rotor. Since the passage of a blade between the emission point and the sensing point blocks the transmission of the acoustic signal between the emission point and the sensing point, the acoustic sensor thus receives, when the rotor is rotating, a signal that is amplitude modulated by the passage of the blades.

Although that prior art device enables a direct measurement to be made of the speed of the turbine rotor with a sensor that is comparatively simple and situated in a cool zone, it nevertheless requires two sound waveguides and an emitter of soundwaves. In addition, detecting the passage of blades by amplitude modulation of soundwaves is applicable only to rotors having a relatively limited number of blades. The frequency of the modulation is equal to the speed of rotation of the rotor multiplied by the number of blades. If the speed of rotation is of the order of 20,000 revolutions per minute (rpm) to 40,000 rpm, then a rotor with ten blades will modulate the amplitude of the acoustic signal at a frequency of the order of 3.3 kilohertz (kHz) to 6.7 kHz. Since the wave carrying the amplitude modulated signal must have a frequency that is significantly higher than the frequency of the modulation, that type of device requires high frequencies (e.g. higher than 80 kHz) when it is applied to turbines in which rotors have a larger number of blades, such as axial turbines as are commonly used in the field of aviation, which may typically have 50 to 100 blades.

In the present disclosure, the object is to propose a device for monitoring a turbine rotor that also has an acoustic sensor and a sound waveguide for connecting said acoustic sensor to a sensing point in the proximity of said turbine rotor, but which makes it possible to monitor turbine rotors that have a large number of blades, while still being particularly simple and thus reliable, and which is also relatively inexpensive.

This object is achieved by the fact that the acoustic sensor of the monitoring device in at least one embodiment is suitable for detecting, as soundwaves, pressure fluctuations corresponding to pressure differences between the suction and pressure sides of blades of the rotor as they move past in the proximity of said sensing point.

With an acoustic sensor having that sensitivity, there is no longer any need to emit a carrier signal in order to detect the passage of the blades, since the rotor itself operates as an acoustic emitter delivering a signal at a frequency that is directly proportional to the number of blades and to the speed of rotation of the rotor. Thus, a rotor having 60 blades and rotating at a speed in the range 20,000 rpm to 40,000 rpm will emit an acoustic signal that remains within a frequency range of 20 kHz to 40 kHz.

Advantageously, the device may include a calculation unit connected to said acoustic sensor. The calculation unit can thus analyze the acoustic signal emitted by the rotor, as transmitted by the sound waveguide and as picked up by the acoustic sensor, in order to calculate a set of parameters about the operation of the rotor. In particular, the calculation unit may be configured to calculate a speed of rotation of the rotor on the basis of the frequency of said soundwaves, said speed of rotation being directly proportional to said frequency and inversely proportional to the number of blades of said rotor. Nevertheless, the calculation unit may alternatively or in addition be configured to calculate other parameters about the operation of the rotor.

Thus, the calculation unit may also be configured to estimate a distance of the rotor from the sensing point on the basis of the amplitude of said soundwaves, thus making it possible for example to determine the clearance of the rotor relative to a ring surrounding it and in which the sensing point is situated, and if there are a plurality of monitoring devices with sensing points at different angular positions around the ring, it is also possible to detect possible deterioration of the ring, such as abrasion or ovalization. The calculation unit may also be configured to indicate blade deterioration if a soundwave picked up by the acoustic sensor presents an amplitude that is significantly different from the mean of a plurality of preceding soundwaves, from a predetermined reference value, from a predetermined range of reference values, and/or from soundwaves picked up by devices of the same type but at different positions, thus indicating one or more blades that are damaged or otherwise deteriorated.

Advantageously, said sound waveguide has an anechoic termination on an end opposite from said sensing point, the acoustic sensor being situated between the sensing point and the anechoic termination. This anechoic termination may for example be in the form of a helix, a spiral, a spiral staircase, or a pigtail, and its section may possibly also vary. It is thus possible to avoid standing waves being set up in the waveguide for soundwaves at certain frequencies. Nevertheless, in particular if the frequency range corresponding to the operating range of the rotor does not include any resonant frequency of the guide, it is also possible merely to envisage situating the acoustic sensor as a termination for the waveguide.

The present disclosure also relates to a turbine stage comprising a rotor with blades that, in operation, present a pressure difference between a pressure side and a suction side, and in order to monitor said rotor, at least one monitoring device comprising an acoustic sensor and a sound waveguide for connecting said acoustic sensor to a sensing point in the proximity of said turbine rotor, said acoustic sensor being suitable for detecting, as soundwaves, pressure fluctuations corresponding to pressure differences between the suction and pressure sides of blades of the rotor as they move past in the proximity of said sensing point.

Advantageously, the sensing point is an orifice in an inside wall around the rotor. In particular, it may be situated facing a central section of a blade profile, a location in which the pressure fluctuation due to pressure differences between the pressure and suction sides of the blades passing in front of the sensing point are the most pronounced. In order to ensure that these fluctuations are well defined, said orifice may present a diameter that is less than the thickness of a blade profile.

The present disclosure also relates to a turbine engine including such a turbine stage and to a method of monitoring a rotor of a turbine, wherein pressure fluctuations due to pressure differences between suction and pressure sides of blades of the rotor going past in the proximity of a sensing point are transmitted by a sound waveguide to an acoustic sensor in order to be picked up as soundwaves.

The invention can be well understood and its advantages appear better on reading the following detailed description of an embodiment given by way of non-limiting example. The description refers to the accompanying drawings, in which:

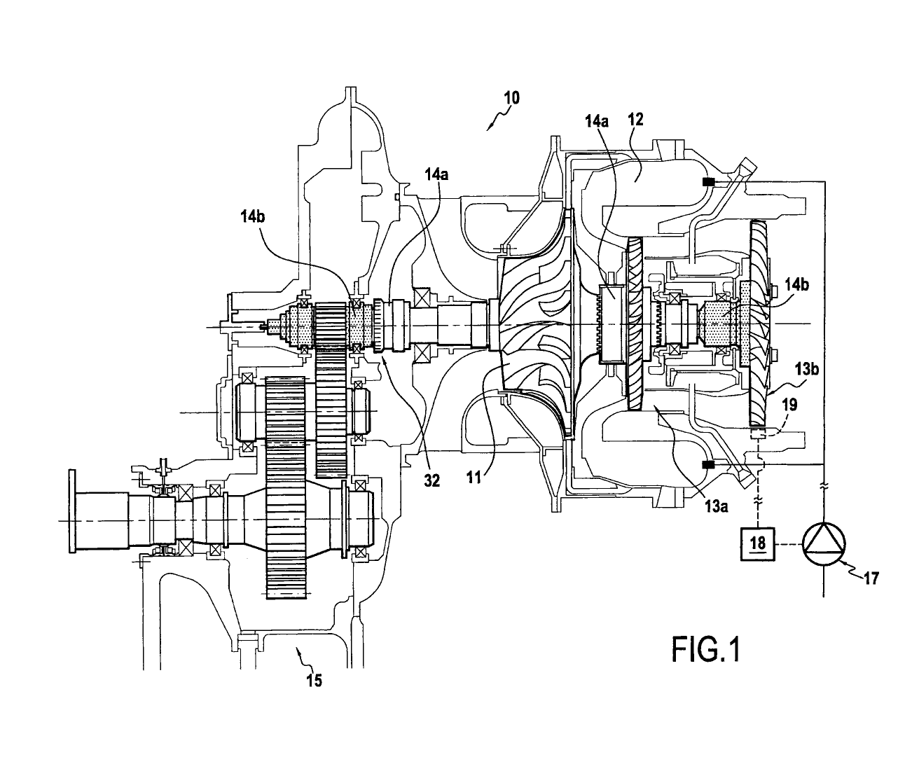

FIG. 1 is a diagrammatic view of a turboshaft engine including a monitoring device in an embodiment;

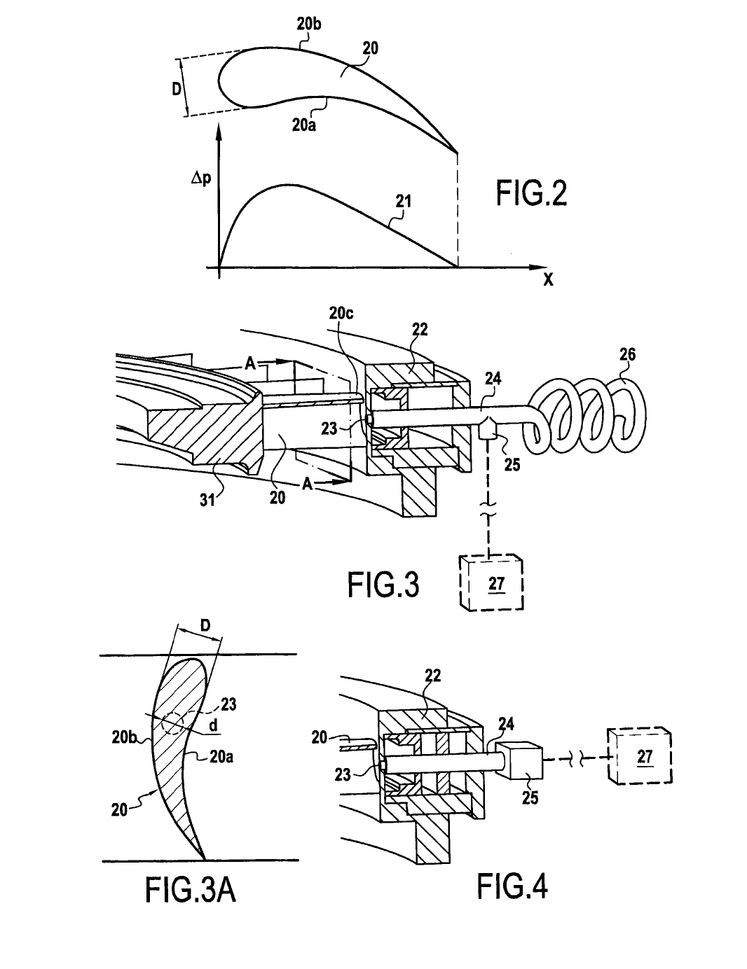

FIG. 2 is a diagram of a turbine blade profile, also showing the pressure difference between the suction side and the pressure side;

FIG. 3 is a diagram of a turbine stage in longitudinal section with a monitoring device in an embodiment;

FIG. 3A is a section of a blade of the FIG. 3 turbine stage on line A-A, showing the sensing point of the monitoring device;

FIG. 4 shows a detail of an alternative embodiment;

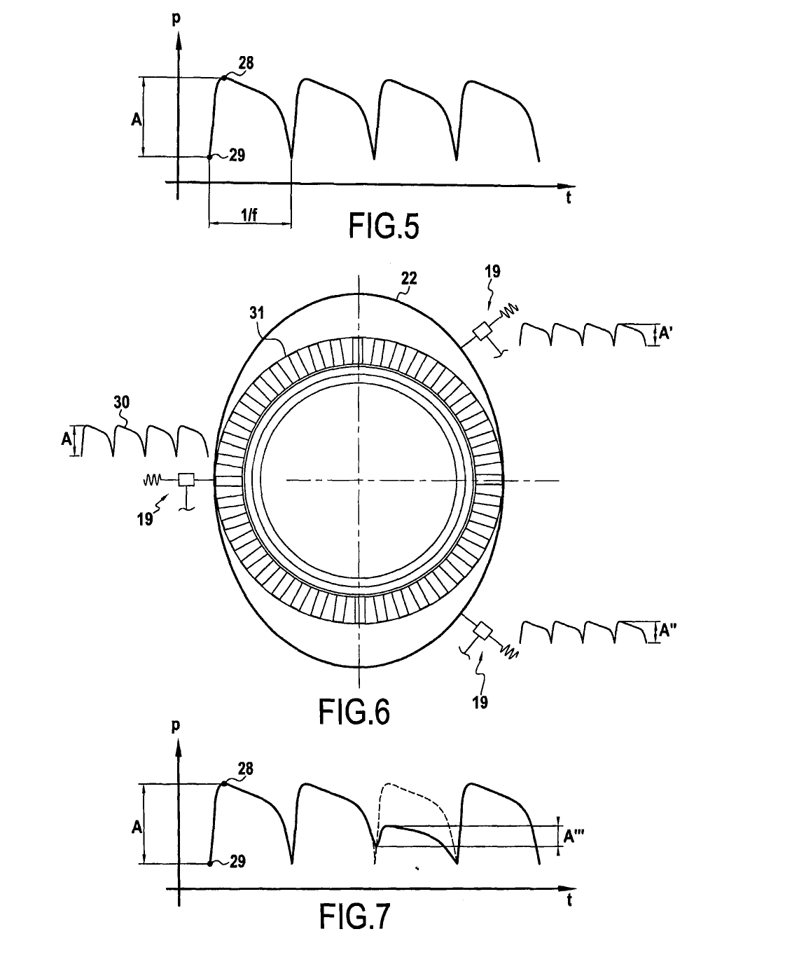

FIG. 5 is a diagram showing the pressure fluctuations caused by the blades going past the vicinity of the FIG. 3 monitoring device;

FIG. 6 shows how a plurality of monitoring devices such as the device shown in FIG. 3, when distributed around a turbine ring, can detect ovalization of the ring; and

FIG. 7 shows how the soundwaves picked up by the FIG. 3 monitoring device can indicate deterioration of a rotor blade.

A turbine engine 10, and more specifically a turboshaft engine of a rotary wing aircraft is shown diagrammatically in FIG. 1. The engine 10 comprises a compressor 11, a combustion chamber 12, and two mutually decoupled turbines 13a and 13b, the compressor 11 and the turbine 13a being coupled together by a common shaft 14a. In operation, air is sucked in and compressed by the compressor 11, and a fuel is injected into the combustion chamber 12 where it is burnt. The expansion of the combustion gas through the turbines 13a and 13b actuates not only the compressor 11 via the rotor of the turbine 13a and the shaft 14a, but also, via the rotor of the turbine 13b, the shaft 14b and a transmission 15 coupled to the shaft 14b, to the rotary wing, and to secondary members of the aircraft (not shown).

In order to regulate the operation of the turbine 10, a system 17 for feeding the combustion chamber 12 with fuel is connected to a control unit 18, which in turn is connected to a device 19 for monitoring the rotor of the turbine 13b in order to receive the signals indicating the speed of the rotor. Thus, in order to make the speed of the rotor safe, the control unit 18 cuts off the flow of fuel in the event of the rotor exceeding a maximum authorized speed or a maximum authorized acceleration. For safety reasons, it is therefore very important to ensure that speed signals received by the control unit are reliable. In particular, the monitoring device 19 underestimating speed may lead to the engine 10 overspeeding. That is why speed measurement by the monitoring device 19 is correlated with the speed measurement as performed conventionally by a phonic wheel 32.

The turbine 13b is an axial stream turbine with a rotor having a plurality of blades 20 oriented radially around the shaft 14b. Each blade 20 presents an airfoil profile such as that shown in FIG. 2, with a pressure side 20a, a suction side 20b, and a thickness D. The stream of combustion gas flowing past the profile gives rise to a pressure difference Δp as represented by curve 21 in the same figure, where pressure difference is plotted as a function of distance x in the flow direction of the combustion gas. It can thus be seen that this pressure difference Δp is particularly marked over a central segment C of the profile of the blade 20.

FIG. 3 is a description longitudinal section of a stage of the turbine 13b. This turbine stage has a plurality of blades 20 arranged radially around the shaft 14b in a rotor 31. A turbine ring 22 surrounds the distal ends 20c of the blades of the turbine 13b, without touching them. In the embodiment shown in FIG. 3, an orifice 23 in the turbine ring 22 forms a sensing point that is connected via a sound waveguide 24 that passes through the turbine ring 22 to an acoustic sensor 25 situated in a cold zone, since it is not suitable for withstanding the temperatures that exist in the close environment of the turbine 13b. This sound waveguide 24 is in the form of an elongate hollow duct between a first end at the sensing point and an opposite end. At its end opposite from the sensing point, the sound waveguide 24 has a helical anechoic termination 26. Other alternative shapes of anechoic termination could be considered, such as terminations in the form of a spiral, a spiral staircase, or a pigtail. They could also be of varying section. In a variant shown in detail in FIG. 4, the acoustic sensor 25 may be placed to terminate the waveguide 24 instead of an anechoic termination, providing there is no risk of resonance in the frequency range being monitored that might lead to resonance generating a standing wave in the waveguide 24. Together, the orifice 23, the waveguide 24, and the sensor 25 form the monitoring device 19. As can be seen in FIG. 3A, the orifice 23 is situated facing the central section C of the profile of the blade 20 where there is the greatest pressure difference Δp between the suction side 20b and the pressure side 20a. The orifice 23 preferably presents a diameter d that is less than the thickness D of the profile of the blade 20 at this section, in such a manner as to avoid overlapping both the suction side 20b and the pressure side 20a at the same time.

The acoustic sensor 25 is connected to a calculation unit 27 that might be incorporated in the control unit 18 or alternatively in the monitoring device 19. When the turbine 13 is in operation, the blades passing in succession past the sensing point give rise to pressure fluctuations at the sensing point, which fluctuations are transmitted as soundwaves at the frequency with which the blades go past, which waves travel along the sound waveguide 24 to the acoustic sensor 25. The sensor 25 is configured to sense these soundwaves and to transmit them in the form of an electrical signal to the calculation unit 27. The pressure fluctuations at the sensing point, and consequently also the soundwaves picked up by the acoustic sensor 25 and the resulting electrical signal, have a form of the kind shown by way of example in FIG. 5. This curve comprises a succession of maxima 28 and minima 29, corresponding respectively to the pressure sides 20a and to the suction sides 20b of the blades 20, at a frequency f corresponding to the frequency with which the blades go past, in such a manner that the speed of rotation of the rotor 31 can be estimated by the calculation unit dividing this frequency f of the signal transmitted by the acoustic sensor 25 by the number of blades in the rotor 31.

As well as the speed of the rotor 31, other operating parameters of the turbine 13 can be inferred from this signal. For example, since the amplitude of the pressure fluctuations at the sensing point decreases with increasing distance between the tips of the blades 20 and the suction point, this distance, or at least the way it varies over time, can also be inferred by the calculation unit 27 on the basis of the amplitude A of the waves in the signal transmitted by the acoustic sensor 25. It is thus possible in particular to measure the clearance between the blades 20 and the turbine ring 22, and thus to detect any degradations of the turbine ring 22 or of the blades 20. In particular, with a plurality of monitoring devices 19 arranged in the turbine ring 22 around the rotor 31, it is possible to detect ovalization of the turbine ring 22, in the manner shown in FIG. 6. Each of the monitoring devices 19 produces a signal 30 of a different amplitude A, A′, A″. Since a larger amplitude for the signal 30 indicates smaller clearance between the rotor and the ring 22 and smaller amplitude indicates greater clearance, this differences in amplitude between the signal indicates that the clearance between the rotor 31 and the ring 22 varies around the circumference of the ring 22, and therefore that the ring presents ovalization as shown (in highly exaggerated manner). The calculation unit 27 may thus be configured to indicate such ovalization on the basis of the signals transmitted by the monitoring devices 19.

The monitoring device 19 may also serve to detect deterioration of the blades 20 individually or as a whole. In the context of the present description, the term “deterioration” is used to mean any change in a blade 20 that might modify its performance, such as lengthening, or indeed wear, and including total or partial breakage of a blade 20. For example, in the particular situation of overspeed, the heating of the blades 20 and centrifugal force can lead to the blades 20 lengthening so that their distal ends 20c come closer to the turbine ring 22 and to the sensing point of the monitoring device 19. The amplitude of pressure fluctuation at the sensing point when such an elongate blade 20 goes past is therefore above a nominal reference value. In contrast, in the event of total or partial breakage of an individual blade 20, the pressure difference between the suction side 20b and the pressure side 20a of the blade will be smaller, with this being manifested in the signal 30 by a wave of amplitude A″ that is significantly smaller than the amplitude A of the preceding signals, as shown in FIG. 7.

The calculation unit 27 can thus also be configured to indicate such ovalization and/or deterioration on the basis of the signal transmitted by one or more monitoring devices 19.

The technology for monitoring the speed of a turbine 13a may be transposed in a manner identical to that described above to the turbine 13b, in particular for monitoring lengthening of the blades of the turbine 13a, which blades are subjected to higher temperatures.

Likewise, the measurement technique based on pressure differences between the pressure and suction sides of a blade profile can also be used for making measurements in a compressor, regardless of whether it is axial, or radial, or centrifugal.

Although the present invention is described above with reference to specific embodiments, it is clear that various modifications and changes may be made to those embodiments without going beyond the general scope of the invention as defined by the claims. Consequently, the description and the drawings should be considered as being illustrative rather than restrictive.

1-10. (canceled)

11. A monitoring device for monitoring a turbine rotor, the monitoring device comprising:
an acoustic sensor; and
a sound waveguide for connecting the acoustic sensor to a sensing point close to the turbine rotor; and
wherein the acoustic sensor is configured to detect, as soundwaves, pressure fluctuations due to pressure differences between suction and pressure sides of blades of the rotor as they move past in proximity of the sensing point.

12. A monitoring device according to claim 11, further comprising a calculation unit connected to the acoustic sensor.

13. A monitoring device according to claim 12, wherein the calculation unit is configured to calculate a speed of rotation of the rotor on the basis of frequency of the soundwaves, the speed of rotation being directly proportional to the frequency and inversely proportional to a number of blades of the rotor.

14. A monitoring device according to claim 11, wherein the sound waveguide includes an anechoic termination on an end opposite from the sensing point, the acoustic sensor situated between the sensing point and the anechoic termination.

15. A turbine stage comprising:
a rotor with blades that, in operation, present a pressure difference between a pressure side and a suction side; and
at least one monitoring device, to monitor the rotor, comprising:
an acoustic sensor; and
a sound waveguide for connecting the acoustic sensor to a sensing point close to the turbine rotor; and
wherein the acoustic sensor is configured to detect, as soundwaves, pressure fluctuations due to the pressure difference between the suction and pressure sides of the blades of the rotor as they move past in proximity of the sensing point.

16. A turbine stage according to claim 15, which is an axial turbine stage and the sensing point is an orifice in an inside wall around the rotor.

17. A turbine stage according to claim 15, wherein the monitoring device further includes a calculation unit connected to the acoustic sensor.

18. A turbine stage according to claim 17, wherein the calculation unit is configured to calculate a speed of rotation of the rotor on the basis of frequency of the soundwaves, the speed of rotation being directly proportional to the frequency and inversely proportional to a number of blades of the rotor.

19. A turbine stage according to claim 15, wherein the sound waveguide includes an anechoic termination on an end opposite from the sensing point, the acoustic sensor situated between the sensing point and the anechoic termination.

20. A turbomachine including at least one turbine stage comprising:
a rotor with blades that, in operation, present a pressure difference between a pressure side and a suction side; and
at least one monitoring device, to monitor the rotor, comprising:
an acoustic sensor; and
a sound waveguide for connecting the acoustic sensor to a sensing point close to the turbine rotor; and
wherein the acoustic sensor is configured to detect, as soundwaves, pressure fluctuations due to the pressure difference between the suction and pressure sides of the blades of the rotor as they move past in proximity of the sensing point.

21. A turbomachine according to claim 20, wherein the turbine stage is in a hot section of the turbomachine, and the acoustic sensor is situated in a cooler zone.

22. A turbomachine according to claim 20, wherein the monitoring device further includes a calculation unit connected to the acoustic sensor.

23. A turbomachine according to claim 22, wherein the calculation unit is configured to calculate a speed of rotation of the rotor on the basis of frequency of the soundwaves, the speed of rotation being directly proportional to the frequency and inversely proportional to a number of blades of the rotor.

24. A turbomachine according to claim 20, wherein the sound waveguide includes an anechoic termination on an end opposite from the sensing point, the acoustic sensor situated between the sensing point and the anechoic termination.

25. A turbomachine according to claim 20, wherein the turbine stage is an axial turbine stage and the sensing point is an orifice in an inside wall around the rotor.

26. A method of monitoring a rotor of a turbine comprising:
transmitting pressure fluctuations due to pressure differences between suction and pressure sides of blades of a rotor going past in proximity of a sensing point by a sound waveguide to an acoustic sensor to be picked up as soundwaves.

27. A monitoring method according to claim 26, wherein a speed of rotation of the rotor is calculated by a calculation unit connected to the acoustic sensor by dividing frequency of the soundwaves by a number of blades of the rotor.
